(19) United States
(12) Patent Application Publication
(10) Pub. No.: US 2009/0148148 A1
(43) Pub. Date: Jun. 11, 2009

(54) PHOTOGRAPHING APPARATUS AND PHOTOGRAPHING METHOD

(75) Inventor: Toshiyuki Tanaka, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/328,985

(22) Filed: Dec. 5, 2008

(30) Foreign Application Priority Data
Dec. 5, 2007 (JP) 2007-314738

(51) Int. Cl. G03B 7/00

(52) U.S. Cl. 396/213

(57) ABSTRACT

A photographing apparatus and method are provided that are capable of suppressing noise generation in a captured image obtained by photographing an object by radiating light uniformly over the entire screen. Such capability results even from a light emitting unit which performs pulse light emission when exposure timing differs for every horizontal line. The photographing apparatus includes an X-Y address type photographing device and exposes the X-Y address type photographing device to photograph an object. The photographing apparatus includes a pulse light emitting unit repeating light emission and light non-emission toward the object in association with a photographing manipulation and a light emission time control unit controlling light emission such that a period of light emission or light non-emission of the pulse light emitting unit is equal to 1/n of an exposure time of the X-Y address type photographing device, wherein n is an integer greater than 1.

### CROSS-REFERENCE TO RELATED PATENT APPLICATION

This application claims the benefit of Japanese Patent Application No. 2007-314738, filed on Dec. 5, 2007 in the Japanese Patent Office, the entire contents of which is incorporated herein by reference.

### BACKGROUND OF THE INVENTION

1. Field of the Invention

The present invention generally relates to a photographing apparatus and a photographing method. More particularly, the present invention relates to a photographing apparatus including an X-Y address type photographing device, and also to a photographing method.

2. Description of the Related Art

In a photographing apparatus such as a compact camera or a single-lens reflex camera, a light emitting device utilizing a xenon tube, which radiates light to an object to supplement light intensity for the object during photographing of the object, has been widely used. It is also suggested that a light emitting diode (LED), which is operable at low voltage and has a simple circuit structure, can be used as a light emitting device in place of a xenon tube. As the development of high-luminance LED technology has continued to progress, it is expected that a photographing apparatus utilizing a high-luminance LED as a light emitting device will be put to practical use.

As the use of an LED as a light emitting device increases, utilization as a daytime synchro intended for backlight correction in an outdoor environment as well as utilization for photographing in a low-illumination scene such as at night or in a dark indoor environment is expected from the LED. In this case, a shutter speed during a photographing operation is higher than when photographing in a low-illumination scene. In other words, an exposure time during which an object is exposed is reduced in such an instance.

Since an LED, if lit up continuously at all times, may be damaged by heat generated therefrom, it generally performs pulse light emission by repeating light emission and light non-emission. See, for example, Japanese Patent Application Laid-Open Publication No. 2005-99349, Japanese Patent Application Laid-Open Publication No. 2005-73227, Japanese Patent Application Laid-Open Publication No. 2006-145877, and Japanese Patent Application Laid-Open Publication No. 2005-128420.

In a situation of using a photographing device, such as a charge coupled device (CCD) image sensor, which initiates and terminates exposure with the same timings for the entire screen, light can be radiated from an LED uniformly over the entire screen. On the other hand, in a situation of using an X-Y address type photographing device, which initiates and terminates exposure with different timings for every horizontal line like in a rolling mode of a complementary metal oxide semiconductor (CMOS) image sensor, the amount of radiation (or a radiation quantity) may differ from line to line according to a timing of pulse light emission.

When an exposure time is sufficiently longer than a pulse period, light can be radiated from an LED uniformly or nearly uniformly over the entire screen even if the timings of initiation and termination of exposure are different line by line. However, in a situation where a shutter speed is high, light from the LED cannot be uniformly radiated over a photographing image, causing horizontal line noise in a captured image obtained by photographing an object. When the LED is used as a flash in the high shutter speed situation, light can be uniformly radiated by reducing the shutter speed to compress an iris. However, when the shutter speed is low, a photographing image may be blurred by a photographer's hand shaking. If the iris is compressed, more light from the LED is required for radiation to the object, which may damage the LED.

In particular, when an LED, which performs pulse light emission, is used as a flash in a high shutter speed situation, an illumination spot may be generated in a rolling mode of a CMOS image sensor. If the illumination spot is generated, horizontal line noise may be generated in a captured image obtained by photographing an object. For this reason, it is necessary to control pulse light emission of the LED in order to prevent generation of the illumination spot.

When an LED is used as a flash for radiating light to an object, it needs to emit light with high light intensity. When the LED emits light with high light intensity, an over shoot is likely to occur at the time of initiation of light emission. When an influence of the over shoot differs from line to line in a photographing image, an illumination spot is generated, causing horizontal line noise in an image obtained by photographing an object.

### SUMMARY OF THE INVENTION

Therefore, the present invention, taking into account the above-discussed problems, provides a photographing apparatus and a photographing method. In the photographing apparatus and photographing method, light from a light emitting unit, which performs pulse light emission, is uniformly radiated over the entire screen even when an exposure timing differs for every horizontal line, thereby preventing generation of noise in a captured image.

According to an embodiment of the present invention, a photographing apparatus is provided. The photographing apparatus includes an X-Y address type photographing device and exposes the X-Y address type photographing device to light to photograph an object. The photographing apparatus includes a pulse light emitting unit repeating light emission and light non-emission toward the object in association with a photographing manipulation and a light emission time control unit controlling light emission such that a period of light emission or light non-emission of the pulse light emitting unit is equal to 1/n of an exposure time of the X-Y address type photographing device, wherein n is an integer greater than 1.

According to this structure, the pulse light emitting unit repeats light emission and light non-emission toward the object in association with a photographing manipulation and a light emission time control unit controls light emission such that a period of light emission or light non-emission of the pulse light emitting unit is equal to 1/n of an exposure time of the X-Y address type photographing device, wherein n is an integer greater than 1. As a result, when the object is photographed by using the X-Y address type photographing device where exposure timing differs for every horizontal line, light emission is controlled such that a period of light emission or light non-emission is equal to 1/n of an exposure time, thereby radiating light from a light emitting unit which performs pulse light emission uniformly over the entire screen obtained by photographing the object.

The light emission time control unit may control light emission of the pulse light emitting unit when an exposure timing of the X-Y address type photographing device differs for every horizontal line.

The light emission time control unit may control light emission of the pulse light emitting unit during exposure. The light emission time control unit may also control light emission of the pulse light emitting unit based on an exposure quantity required for photographing the object.

The pulse light emitting unit may include a plurality of light emitting units which emit light at the same wavelength or different wavelengths, and the light emission time control unit may independently control a period of light emission or light non-emission for each of the plurality of light emitting units which emit light at the same wavelength or different wavelengths.

When the plurality of light emitting units emit light at the same wavelength, each of the plurality of light emitting units may emit light with different phases.

The light emission time control unit may control light emission of each of the plurality of light emitting units when an exposure timing of the X-Y address type photographing device differs for every horizontal line.

The light emission time control unit may control light emission of each of the plurality of light emitting units during exposure. The light emission time control unit may control light emission of each of the plurality of light emitting units based on an exposure quantity required for photographing the object.

The light emission time control unit may control light emission of each of the plurality of light emitting units such that a period of light emission or light non-emission differs for each of the plurality of light emitting units. The light emission time control unit may also control light emission of each of the plurality of light emitting units such that a duty ratio differs for each of the plurality of light emitting units.

According to another embodiment of the present invention, a photographing method is provided. The photographing method photographs an object by exposing an X-Y address type photographing device to light. The photographing method includes a pulse light emitting operation of repeating light emission and light non-emission toward the object in association with a photographing manipulation and a light emission time control operation of controlling light emission such that a period of light emission or light non-emission of the pulse light emitting operation is equal to 1/n of an exposure time of the X-Y address type photographing device, wherein n is an integer greater than 1.

### BRIEF DESCRIPTION OF THE DRAWINGS

The above and other features and advantages of the present invention will become more apparent by describing in detail embodiments thereof with reference to the attached drawings in which:

FIG. 1 is an explanatory view showing an example of a relationship between exposure time and pulse light emission of a light emitting diode (LED) when a charge coupled device (CCD) image sensor is used as a photographing device;

FIG. 2 is an explanatory view showing an example of a relationship between exposure time and pulse light emission of an LED when a rolling mode of a CMOS image sensor is used;

FIG. 3 is an explanatory view showing an example of a case where timings of initiation and termination of exposure differ for every horizontal line;

FIG. 4 is an explanatory view showing an example of a relationship between exposure time and pulse light emission of an LED when the LED is continuously lighted up to radiate light to an object during exposure;

FIG. 5 is an explanatory diagram showing an example of a structure of a photographing apparatus according to a first embodiment of the present invention;

FIG. 6 is a flowchart illustrating an example of a pulse specifications determining method used in an LED pulse specifications determining unit according to the first embodiment of the present invention;

FIG. 7 is an explanatory view showing an example of a relationship between exposure time and pulse light emission of an LED in the photographing apparatus according to the first embodiment of the present invention;

FIG. 8 is an explanatory view showing an example of a relationship between exposure time and pulse light emission of an LED in the photographing apparatus according to the first embodiment of the present invention;

FIG. 9 is an explanatory view showing an example of a relationship between exposure time and pulse light emission of an LED in the photographing apparatus according to the first embodiment of the present invention;

FIG. 10 is an explanatory view showing an example of a relationship between exposure time and pulse light emission of an LED in the photographing apparatus according to the first embodiment of the present invention;

FIG. 11 is an explanatory view showing an example of a relationship between exposure time and pulse light emission of an LED in the photographing apparatus according to the first embodiment of the present invention;

FIG. 12 is an explanatory view showing an example of a relationship between exposure time and pulse light emission of an LED in the photographing apparatus according to the first embodiment of the present invention;

FIG. 13 is an explanatory view showing an example of a relationship between exposure time and pulse light emission of an LED in the photographing apparatus according to the first embodiment of the present invention;

FIG. 14 is an explanatory view showing an example of a relationship between exposure time and pulse light emission of an LED in the photographing apparatus according to the first embodiment of the present invention;

FIG. 15 is an explanatory view showing an example of a relationship between exposure time and pulse light emission of an LED in the photographing apparatus according to the first embodiment of the present invention;

FIG. 16 is an explanatory view showing an example of a relationship between exposure time and pulse light emission of an LED in the photographing apparatus according to the first embodiment of the present invention;

FIG. 17 is an explanatory view showing an example of a relationship between exposure time and pulse light emission of an LED when a pulse light emission period of the LED is set to k/n of an exposure time;

FIG. 18 is an explanatory view showing an example of a relationship between exposure time and pulse light emission of an LED when a pulse light emission period of the LED is set to k/n of an exposure time;

FIG. 19 is an explanatory view showing an example of a relationship between exposure time and pulse light emission of an LED when a pulse light emission period of the LED is set to k/n of an exposure time;

FIG. 20 is an explanatory view showing an example of a relationship between exposure time and pulse light emission of an LED in the photographing apparatus according to the first embodiment of the present invention;

FIG. 21 is an explanatory view showing an example of a relationship between exposure time and pulse light emission of an LED in a photographing apparatus according to a second embodiment of the present invention; and

FIG. 22 is an explanatory view showing an example of an over shoot generated when a light emission quantity per pulse is increased.

### DETAILED DESCRIPTION OF THE INVENTION

Hereinafter, very suitable embodiments of the present invention will be described in detail with reference to the accompanying drawings. Throughout the specification and drawings, components having substantially the same functional configurations will be given the same reference numerals to avoid repetitive description.

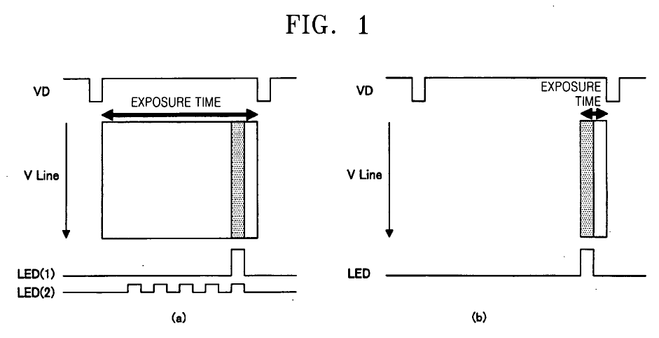

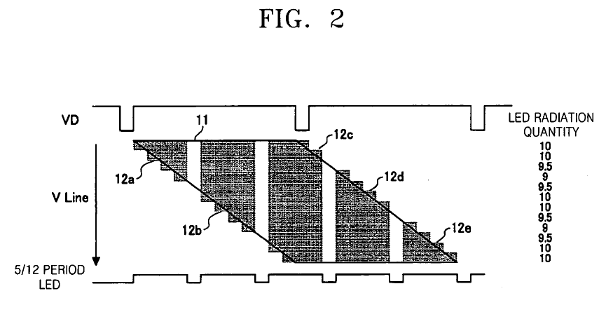

First, a description will be made of a difference in terms of light radiated to a screen between a photographing device which uses the same exposure timing for the entire screen like in a charge coupled device (CCD) image sensor and a photographing device which uses different exposure timings for every horizontal line like in a rolling mode of a complementary metal oxide semiconductor (CMOS) image sensor when a light emitting diode (LED), which is an example of a light emitting unit performing pulse light emission, is used as a flash. FIG. 1 is an explanatory view showing an example of a relationship between exposure time and pulse light emission of an LED when a CCD image sensor is used as a photographing device. FIG. 2 is an explanatory view showing an example of a relationship between exposure time and pulse light emission of an LED when a rolling mode of a CMOS image sensor is used.

As shown in the example of FIG. 1, when the entire screen is exposed with the same exposure timing like when a CCD image sensor is used for a photographing device, in case of using an LED as a flash, an image can be obtained with uniform light radiation from the LED over the entire screen because the timings of initiation and termination of exposure are the same across horizontal lines (V Line). In FIGS. 1 and 2, VD represents a vertical sync pulse and the LED may perform single light emission or pulse light emission.

As shown in the example of FIG. 2, when the rolling mode of the CMOS image sensor is utilized, the timings of initiation and termination of exposure differ for every horizontal line. In FIG. 2, a light emission period is 5/12 of an exposure time on the assumption that the number of horizontal lines (V Line) is 12. In FIG. 2, a reference numeral 11 represents an exposure range defined by a parallelogram and reference numerals 12a through 12e represent radiation ranges where light is radiated by pulse light emission of the LED.

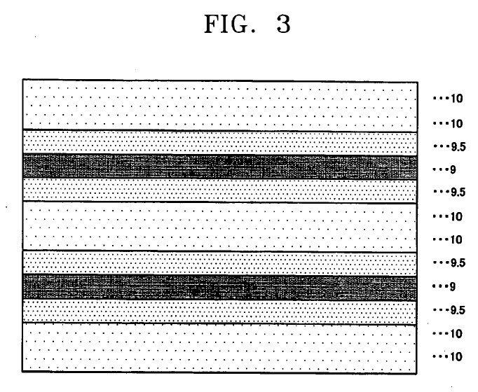

In a situation of pulse light emission when the timings of initiation and termination of exposure differ for every horizontal line, an integral of LED radiation quantities, which is obtained by integrating the amounts of radiation from the LED (hereinafter, an integral of LED radiation quantities in a single horizontal line will be briefly referred to as an ‘LED radiation quantity’), is also different between horizontal lines. In an example shown in FIG. 2, there is a time difference of about 1 VD between a top horizontal line and a bottom horizontal line. For a light emission period of an LED being 5/12 of an exposure time, the difference of an LED radiation quantity between horizontal lines is about 9-10. In a situation where LED radiation quantities are different between horizontal lines, if light is radiated from the LED to an object having a uniform color, for example, a white wall, to photograph the object, horizontal lines are generated due to luminance spots as shown in FIG. 3. FIG. 3 is an explanatory view showing an example of a case where timings of initiation and termination of exposure differ for every horizontal line.

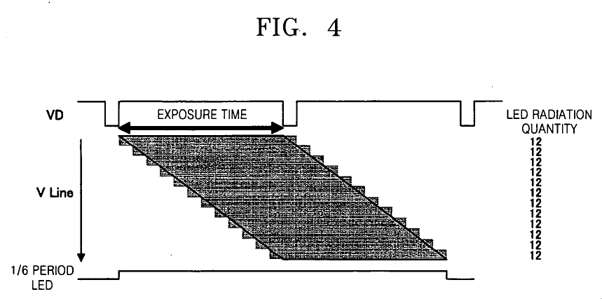

In order to prevent generation of the luminance spots, the LED may be continuously lit up during exposure. FIG. 4 is an explanatory view showing an example of a relationship between exposure time and pulse light emission of an LED when the LED is continuously lit up during exposure to continuously radiate light to an object. As shown in the example of FIG. 4, even when a rolling mode of a CMOS image sensor is used, there is no difference in LED radiation quantity between horizontal lines by continuously lighting up the LED during exposure to continuously radiate light to the object.

However, it is general that a VD period is set to 1/30- 1/60 second. In this case, about 1/15- 1/30 second is required to continuously light up an LED. In order to prevent the LED from being damaged by continuous lighting for that time, a value of an electric current flowing to the LED is highly restricted, making it difficult for the LED to emit light with high light intensity.

Therefore, in the present invention, a luminance spot is suppressed by controlling one period of light emission or light non-emission in such a way to uniformly radiate light to the object, thereby preventing generation of a horizontal line. Hereinafter, very suitable embodiments of the present invention will be described in detail.

### FIRST EMBODIMENT

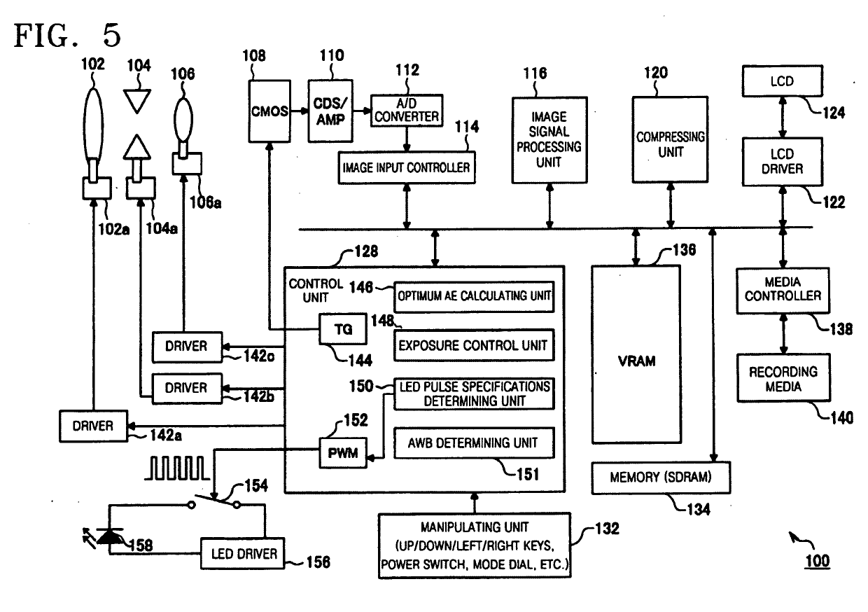

A description will now be made of a photographing apparatus and a photographing method according to a first embodiment of the present invention. FIG. 5 is an explanatory diagram showing an example of a structure of the photographing apparatus according to the first embodiment of the present invention. Hereinafter, the structure of the photographing apparatus according to the first embodiment of the present invention will be described with reference to FIG. 5.

As shown in the example of FIG. 5, a photographing apparatus 100 according to the first embodiment of the present invention includes a zoom lens 102, an iris 104, a focusing lens 106, driving devices 102a, 104a, and 106a, a CMOS image sensor 108, an amp-integrated CDS (correlated double sampling) circuit 110, an analog-to-digital (A/D) converter 112, an image input controller 114, an image signal processing unit 116, a compressing unit 120, a liquid crystal display (LCD) driver 122, an LCD 124, a control unit 128, a manipulating unit 132, a memory 134, a video random access memory (VRAM) 136, a media controller 138, a recording media 140, motor drivers 142a, 142b, and 142c, a switch 154, an LED driver 156, and an LED 158.

By moving it forward and backward along an optical axis direction, the zoom lens 102 has a focal distance which continuously changes. The zoom lens 102 photographs an object while changing the size of the object. The iris 104 adjusts the intensity of light coming to the CMOS image sensor 108 through the driving device 104a while photographing of the object. The focusing lens 106 adjusts a pint of an object by moving forward and backward along the optical axis direction by the driving device 106a. In the current embodiment, the focusing lens 106 is driven from a long distance to a short distance to perform exposure control with a plurality of exposure times, thereby obtaining an in-focus evaluation value.

Although each of the zoom lens 102 and the focusing lens 106 is shown as one sheet in the example of the current embodiment, the number of sheets of each of the zoom lens 102 and the focusing lens 106 may be greater than 2.

The CMOS image sensor 108, which is an example of an X-Y address type photographing device according to the present invention, is utilized to convert light incident from the zoom lens 102, the iris 104, and the focusing lens 106 into an electric signal. While the time for extracting the electric signal is adjusted by controlling the incident light with an electronic shutter in the current embodiment, it may also be adjusted by controlling the incident light with a mechanical shutter.

The CDS circuit 110 is a circuit where a CDS circuit, which is a sort of sampling circuit for removing noise from the electric signal being output from the CMOS image sensor 108, and an amplifier for amplifying the noise-removed electric signal are integrated. Although the photographing apparatus 100 utilizes the CDS circuit 110 where the CDS circuit and the amplifier are integrated in the current embodiment of the present invention, it may also use separate circuits for the CDS circuit and the amplifier.

The A/D converter 112 converts the electric signal generated by the CMOS image sensor 108 into a digital signal in order to generate raw data of an image.

The image input controller 114 controls input of the raw data, generated by the A/D converter 112, to the memory 134.

For the raw data generated by the A/D converter 112, the image signal processing unit 116 corrects a gain of light intensity or adjusts a white balance. The image signal processing unit 116 functions as an exposure data obtaining unit of the present invention and obtains exposure data of a captured image. The exposure data includes an in-focus evaluation value (auto focus (AF) evaluation value) or an auto exposure (AE) evaluation value which is calculated by the image signal processing unit 116.

The compressing unit 120 compresses an image which undergoes correction of a gain of light intensity or adjustment of a white balance in the image signal processing unit 116 into image data in a suitable format. The image compression format may be a reversible format or an irreversible format. For example, the suitable format may be a joint photographic experts group (JPEG) format or a JPEG2000 format.

The LCD 124 displays a live view prior to photographing, various setting screens of the photographing apparatus 100, or a captured image, for example. Display of image data or various information of the photographing apparatus 100 on the LCD 124 is performed through the LCD driver 122.

The control unit 128 issues a signal system command for the CMOS image sensor 108 or the CDS circuit 110 or a manipulation system command for the manipulating unit 132. Although a single control unit is provided in the current embodiment of the present invention, different control units, e.g., a central processing unit (CPU) and a digital signal processor (DSP) may issue the signal system command and the manipulation system command, respectively.

In the manipulating unit 132, a member for performing manipulation of the photographing apparatus 100 or executing various settings during photographing is arranged. The member arranged in the manipulating unit 132 may include a power button, a cross key and a select button for selecting a photographing mode or a photographing drive mode and setting an effect parameter, and a shutter button for initiating photographing of an object.

The memory 134 temporarily memorizes a captured image. The memory 134 has a memory capacity capable of memorizing a plurality of images. Reading/writing of an image from/to the memory 134 is controlled by the image input controller 114. For the memory 134, a synchronous dynamic random access memory (SDRAM), for example, may be used as shown in FIG. 5.

The VRAM 136 retains data displayed on the LCD 124 and the resolution of the LCD 124 or the maximum number of colors of the LCD 124 is dependent on the capacity of the VRAM 136.

The recording media 140, which is an example of an image recording unit, records a captured image or an image synthesized by an image synthesizing unit. Input/output to/from the recording media 140 is controlled by the media controller 138. For the recording media 140, a card-type memory device, a memory card may be used, for example, which records data in a flash memory.

The motor drivers 142a, 142b, and 142c control the driving devices 102a, 104a, and 106a which actuate the zoom lens 102, the iris 104, and the focusing lens 106. By actuating the zoom lens 102, the iris 104, and the focusing lens 106 through the motor drivers 142a, 142b, and 142c, the size of an object, the intensity of light, or the pint of the object can be adjusted.

The switch 154 is turned on or off based on a high or low state of a pulse being output from the control unit 128 in order to control supply of an electric current from the LED driver 156 to the LED 158. The LED driver 156 supplies an electric current to the LED 158. The LED 158, which is an example of a light emitting unit according to the present invention, is provided with an electric current from the LED driver 156 to emit light. The timing of light emission of the LED 158 is controlled by an on or off state of the switch 154.

For the switch 154, a transistor which transits to an on or off state in a high or low state of a pulse may be used. The LED driver 156 may operate to output a constant voltage or operate with constant power. The LED 158 may include only a single LED emitting light of the same color or a plurality of LEDs emitting light of the same color. The photographing apparatus 100 according to the present invention may further include an LED emitting light of another color, and in this case, a plurality of switches 154 may be provided for individual colors.

The control unit 128 in this example includes a timing generator (TG) 144, an optimum AE calculating unit 146, an exposure control unit 148, an LED pulse specifications determining unit 150, an auto white balance (AWB) determining unit 151, and a pulse width modulator (PWM) 152.

The TG 144 inputs a timing signal to the CMOS image sensor 108. A shutter speed is determined by the timing signal being input from the TG 144. In other words, driving of the CMOS image sensor 108 is controlled by the timing signal being input from the TG 144, and an image light from an object is incident during driving of the CMOS image sensor 108, thereby generating an electric signal which is a basis of image data.

The optimum AE calculating unit 146 performs auto exposure in the photographing apparatus 100 to obtain an exposure value (EV). An optimum set of an exposure time and a shutter speed is determined based on the obtained EV. The EV is set to 0 for a light quantity where an optimum exposure is obtained for an iris value F1 and a shutter speed of 1 second, and the EV is changed by changing the iris value F1 or the shutter speed. The EV can be obtained by EV=log₂(F²/T) where F indicates an iris value and T indicates a shutter speed. Thus, the EV increases as the shutter speed increases for the same iris value, and the EV also increases as the iris value increases for the same shutter speed.

The exposure control unit 148 determines an exposure time during photographing of an object based on the exposure time calculated by the optimum AE calculating unit 146. The exposure control unit 148 controls the incident time of the image light from the object into the CMOS image sensor 108 based on the determined exposure time.

The LED pulse specifications determining unit 150, which is an example of a light emitting time control unit according to the present invention, determines specifications of a pulse which turns on or off the switch 154 for light emission of the LED 158. The LED pulse specifications determining unit 150 determines the pulse specifications based on the EV obtained by the optimum AE calculating unit 146 or based on an optimum color state determined by the AWB determining unit 151. The PWM 152 controls the width of the pulse to be output to the switch 154 based on the pulse specifications determined by the LED pulse specifications determining unit 150.

The structure of the photographing apparatus 100 according to the first embodiment of the present invention has been described. Next, a description will be made of a pulse specifications determining method according to the first embodiment of the present invention.

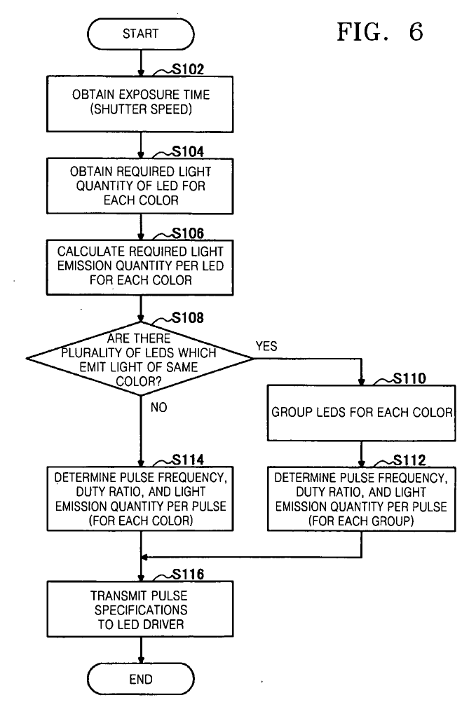

FIG. 6 is a flowchart illustrating an example of a pulse specifications determining method used in the LED pulse specifications determining unit 150 according to the first embodiment of the present invention. Hereinafter, the pulse specifications determining method used in the LED pulse specifications determining unit 150 according to the first embodiment of the present invention will be described with reference to the example of FIG. 6.

In order for the LED pulse specifications determining unit 150 to determine pulse specifications, an exposure time (a shutter speed) required for photographing an object is obtained in operation S102. The exposure time required for photographing the object is obtained by the optimum AE calculating unit 146. Once the exposure time required for photographing the object is obtained, a required light emission quantity of the LED 158 is obtained in operation S104. If there are a plurality of LEDs which emit light at different wavelengths, i.e., emit light of different colors, the required light emission quantity of the LED 158 is obtained for each of the colors.

Once the required light emission quantity of the LED 158 is obtained, a required light emission quantity per LED is calculated in operation S106. When there are a plurality of LEDs which emit light of different colors, a required light emission quantity per LED is calculated for each of the colors.

When the calculation of the required light emission quantity per LED is completed, prior to determination of pulse specifications, a check is made of whether or not there are a plurality of LEDs 158 which emit light of the same color in operation S108. If there are a plurality of LEDs 158 which emit light of the same color, the LEDs 158 are grouped for each color in operation S110 and pulse specifications (for example, a pulse frequency, a duty ratio, and a light emission quantity per pulse) are determined for each group in operation S112. If there is only one LED 158 which emits light of the same color, pulse specifications (for example, a pulse frequency, a duty ratio, and a light emission quantity per pulse) are determined for each color in operation S114.

The pulse specifications determined by the LED pulse specifications determining unit 150 in operations S112 and S114 are transmitted to the LED driver 156 in operation S116. The LED driver 156, having received the pulse specifications determined by the LED pulse specifications determining unit 150, controls light emission of the LED 158 based on the received pulse specifications. In the current embodiment, the supply of an electric current from the LED driver 156 to the LED 158 is controlled by repeating turning on or off of the switch 154 based on the pulse specifications determined by the LED pulse specifications determining unit 150.

In this example of the present invention, a pulse period is set to 1/n of an exposure time of the CMOS image sensor 108, whereby an integral of radiation quantities of the LED 158 in each horizontal line is constant and thus it is possible to prevent a horizontal line noise from being generated in a captured image obtained by photographing an object. Herein, n is an integer greater than 1. In addition, the pulse period may be determined taking into account light intensity required by the photographing apparatus 100, the durability of the LED 158 (a light emission quantity per pulse or a frequency which does not cause destruction or deterioration), and optimization of light emission efficiency (a duty ratio or a light emission quantity per pulse which reduces power consumption).

Hereinafter, a description will be made of a relationship between exposure time and pulse light emission of the LED 158 for a pulse light emission period of the LED 158 being set to 1/n of an exposure time of the CMOS image sensor 108.

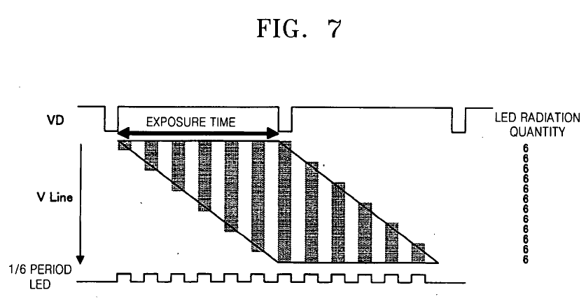

FIGS. 7 through 11 are explanatory views showing examples of relationships between exposure time and pulse light emission of the LED 158 for a pulse light emission period of the LED 158 being set to 1/n of an exposure time of the CMOS image sensor 108. FIGS. 7 through 11 show situations where an exposure time of a single horizontal line is the same as a VD period. Although the number of horizontal lines is assumed to be 12 in each of the examples of FIGS. 7 through 11, it is not limited to such an example in the present invention. A set pulse period or a set duty ratio is not limited to the above example, and if a pulse light emission period of the LED 158 is set to 1/n of an exposure time of the CMOS image sensor 108, a duty ratio may be set to have a pattern other than those shown in FIGS. 7 through 11.

In FIG. 7, a pulse period is set to ⅙ of an exposure time. As a result, it can be seen that integrals of radiation quantities for every horizontal line are all 6 and light is radiated from the LED 158 uniformly over the entire screen.

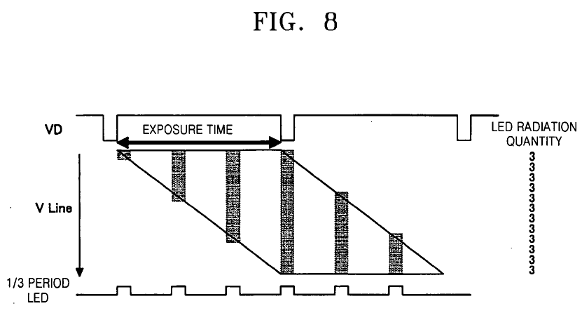

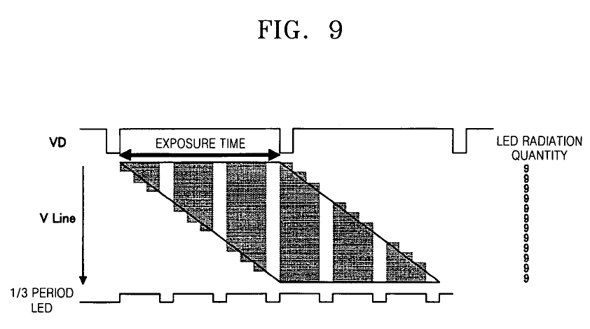

In FIG. 8, a pulse period is set to ⅓ of an exposure time. As a result, it can be seen that integrals of radiation quantities for every horizontal line are all 3 and light is radiated from the LED 158 uniformly over the entire screen. In FIG. 9, a pulse period is set to ⅓ of an exposure time like in FIG. 8, but a duty ratio is different from that in FIG. 8. Also in this case, it can be seen that integrals of radiation quantities for every horizontal line are all 9 and light is radiated from the LED 158 uniformly over the entire screen.

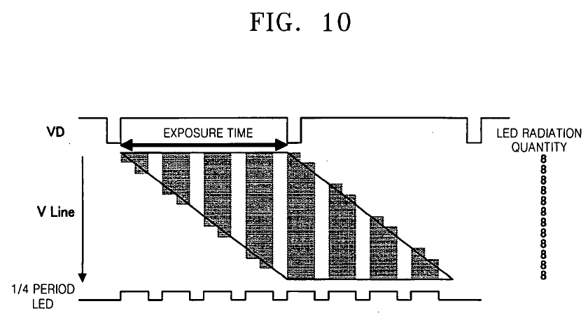

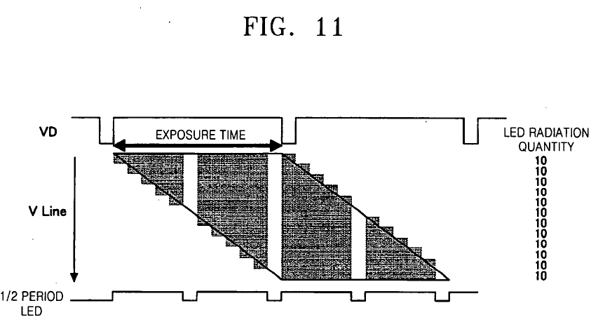

In FIG. 10, a pulse period is set to ¼ of an exposure time. As a result, it can be seen that integrals of radiation quantities for every horizontal line are all 8 and light is radiated from the LED 158 uniformly over the entire screen. In FIG. 11, a pulse period is set to ½ of an exposure time. As a result, it can be seen that integrals of radiation quantities for every horizontal line are all 10 and light is radiated from the LED 158 uniformly over the entire screen.

In this way, when an exposure time of a single horizontal line is the same as a VD period, by setting a pulse light emission period of the LED 158 to 1/n of an exposure time to the CMOS image sensor 108, light can be radiated from the LED 158 uniformly over the entire screen. By radiating light from the LED 158 uniformly over the entire screen, a luminance spot in a captured image is suppressed, thereby preventing generation of a horizontal line noise in the captured image.

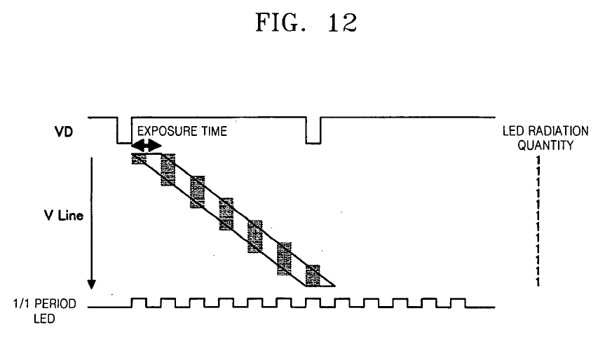

FIGS. 12 through 16 are explanatory views showing examples of relationships between exposure time and pulse light emission of the LED 158 for a pulse light emission period of the LED 158 being set to 1/n of an exposure time of the CMOS image sensor 108 in the photographing apparatus 100 according to the first embodiment of the present invention. FIGS. 12 through 16 show situations where an exposure time of a single horizontal line is less than a VD period. Although the number of horizontal lines is assumed to be 12 also in each of the examples of FIGS. 12 through 16, it is not limited to such an example in the present invention. A set pulse period or a set duty ratio is not limited to the above example, and if a pulse light emission period of the LED 158 is set to 1/n of an exposure time of the CMOS image sensor 108, a duty ratio may be set to have a pattern other than those shown in FIGS. 12 through 16.

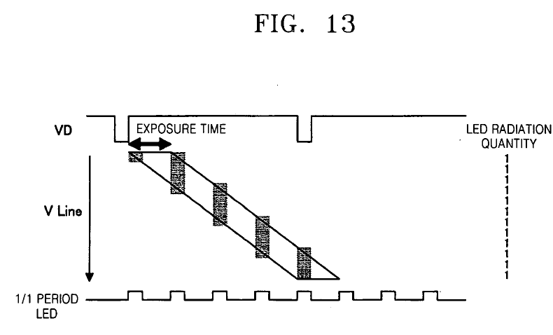

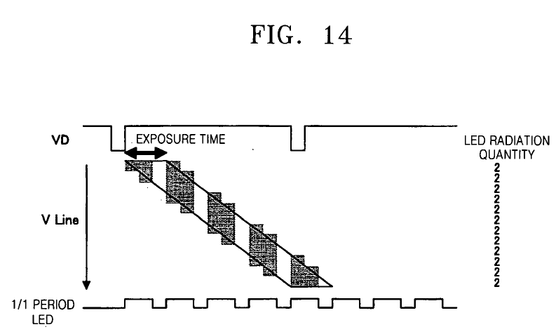

In FIG. 12, a pulse period is set to 1/1 of an exposure time. As a result, it can be seen that integrals of radiation quantities for every horizontal line are all 1 and light is radiated from the LED 158 uniformly over the entire screen. In FIG. 13, a pulse period is set to 1/1 of an exposure time like in FIG. 12, but a duty ratio is different from that in FIG. 12. Also in this case, it can be seen that integrals of radiation quantities for every horizontal line are all 1 and light is radiated from the LED 158 uniformly over the entire screen. In FIG. 14, a pulse period is set to 1/1 of an exposure time like in FIGS. 12 and 13, but a duty ratio is different from those in FIGS. 12 and 13. As a result, it can be seen that integrals of radiation quantities for every horizontal line are all 2 and light is radiated from the LED 158 uniformly over the entire screen.

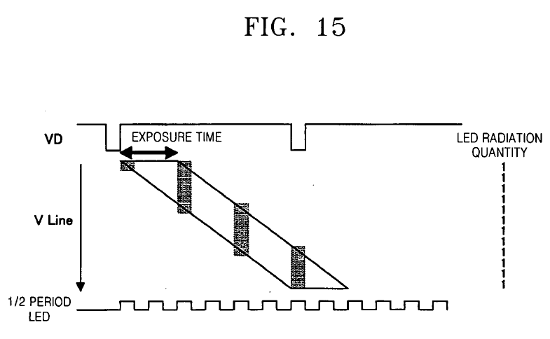

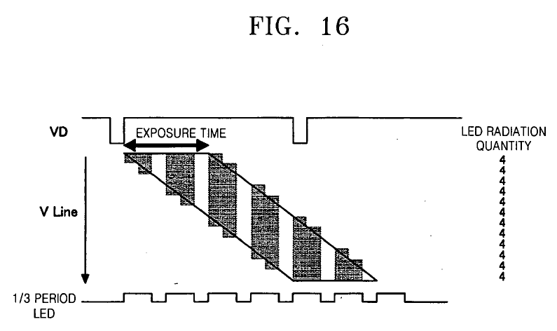

In FIG. 15, a pulse period is set to ½ of an exposure time. As a result, it can be seen that integrals of radiation quantities for every horizontal line are all 1 and light is radiated from the LED 158 uniformly over the entire screen. In FIG. 16, a pulse period is set to ⅓ of an exposure time. As a result, it can be seen that integrals of radiation quantities for every horizontal line are all 4 and light is radiated from the LED 158 uniformly over the entire screen.

As such, even when an exposure time of a single horizontal line is less than a VD period, by setting a pulse light emission period of the LED 158 to 1/n of an exposure time of the CMOS image sensor 108, light can be radiated from the LED 158 uniformly over the entire screen. Moreover, by radiating light from the LED 158 uniformly over the entire screen, a luminance spot in a captured image is suppressed, thereby preventing generation of a horizontal line noise.

Next, a description will be made of a relationship between exposure time and pulse light emission of the LED 158 for a pulse light emission period of the LED 158 being set to k/n of an exposure time to the CMOS image sensor 108. In this regard, k is an integer which is greater than 2 and is not a multiple of n.

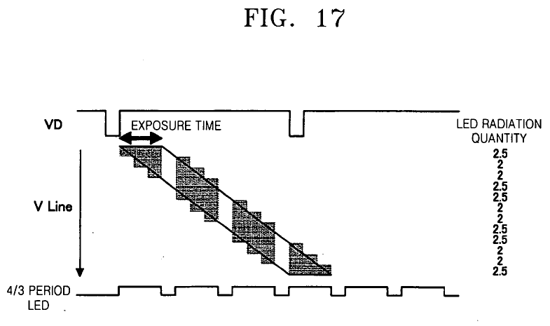

FIGS. 17 through 19 are explanatory views showing examples of relationships between exposure time and pulse light emission of the LED 158 for a pulse light emission period of the LED 158 being set to k/n of an exposure time of the CMOS image sensor 108 in the photographing apparatus 100 according to the first embodiment of the present invention. In FIG. 17, a pulse period is set to 4/3 of an exposure time. As a result, it can be seen that integrals of radiation quantities for horizontal lines vary between 2-2.5 and light is not uniformly radiated from the LED 158 over the entire screen.

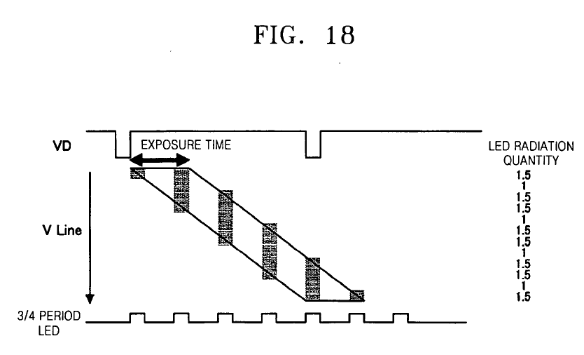

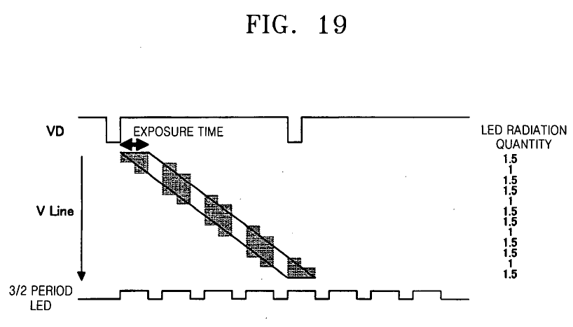

In FIG. 18, a pulse period is set to ¾ of an exposure time. As a result, it can be seen that integrals of radiation quantities for horizontal lines vary between 1-1.5 and light is not uniformly radiated from the LED 158 over the entire screen. In FIG. 19, a pulse period is set to 3/2 of an exposure time. As a result, it can be seen that integrals of radiation quantities for horizontal lines vary between 1-1.5 and light is not uniformly radiated from the LED 158 over the entire screen.

As such, when the pulse light emission period of the LED 158 is set to k/n, instead of 1/n, of an exposure time of the CMOS image sensor 108, light cannot be uniformly radiated from the LED 158 over the entire screen because integrals of radiation quantities differ for every horizontal line.

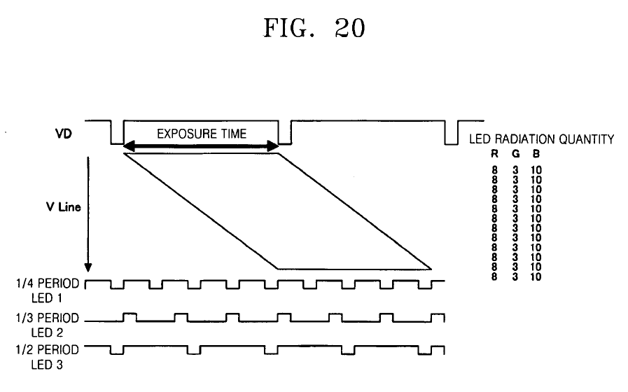

Also, when a flash is provided in the form of a combination of a plurality of LEDs which emit light at different wavelengths, the pulse light emission period of each of the LEDs may be set to 1/n of the exposure time as described above in order to radiate light from the plurality of LEDs over the entire screen. FIG. 20 is an explanatory view showing an example of a relationship between exposure time and pulse light emission of the LED 158 when each pulse light emission period of the LED 158 which emits light at 3 different wavelengths is set to 1/n of an exposure time in the photographing apparatus 100 according to the first embodiment of the present invention. FIG. 20 shows a situation where an exposure time of a single horizontal line is the same as a VD period. Although the number of horizontal lines is assumed to be 12 also in the example of FIG. 20, it is not limited to such an example in the present invention. A set pulse period or a set duty ratio is not limited to the above example, and if the pulse light emission period of the LED 158 is set to 1/n of an exposure time per horizontal line, a duty ratio may be separately set to have a pattern other than those shown in FIG. 20.

In FIG. 20, an LED which emits red color light is indicated by LED 1, an LED which emits green color light is indicated by LED 2, an LED which emits blue color light is indicated by LED 3. Also, pulse light emission periods of those LEDs are set to ¼, ⅓, and ½ of an exposure time of the CMOS image sensor 108, respectively. As a result, it can be seen that integrals of radiation quantities from the LED 1 are all 8 for horizontal lines, integrals of radiation quantities from the LED 2 are all 3 for horizontal lines, integrals of radiation quantities from the LED 3 are all 10 for horizontal lines, and light from any LED is radiated uniformly over the entire screen.

It is desirable to set a pulse light emission period of each LED in such a way to facilitate calculation of a white balance, by taking account of a photographing environment where photographing is performed by using the photographing apparatus 100 or spectral characteristics of the CMOS image sensor 108 of the photographing apparatus 100.

In the foregoing discussion, a description has been presented of the pulse specifications determining method used in the LED pulse specifications determining unit 150 according to the first embodiment of the present invention.

As described above, according to the first embodiment of the present invention, even in a situation of utilizing a photographing device where exposure timings differ from line to line like in a rolling mode of a CMOS image sensor, by setting a pulse light emission period of an LED to 1/n of an exposure time per horizontal line, light from a light emitting unit which performs pulse light emission can be radiated uniformly over the entire screen. Since light can be radiated from the light emitting unit uniformly over the entire screen, it is possible to suppress generation of noise in a captured image obtained by photographing an object. Moreover, an LED does not need to emit light continuously during exposure of all horizontal lines, thus suppressing damage of the LED, or radiating light to the object with high light intensity even when the LED is used as a flash.

### SECOND EMBODIMENT

In the first embodiment of the present invention, a description has been made of the photographing apparatus and the photographing method where a pulse light emission period of a single LED which emits light at the same wavelength is set to 1/n of an exposure time per horizontal line. However, light intensity which is sufficient to radiate light to an object may not be obtained from a single LED which emits light at the same wavelength. Thus, in the second embodiment of the present invention, a description will be made of a photographing apparatus and a photographing method where a plurality of LEDs which emit light at the same wavelength are used as a flash to radiate light to the object.

The photographing apparatus according to the second embodiment of the present invention has a structure that is similar to that of the photographing apparatus 100 according to the first embodiment of the present invention except that a plurality of LEDs which emit light at the same wavelength are provided, and thus a description thereof will not be provided. Hereinafter, a description will be made of a relationship between exposure time and pulse light emission of each LED in the photographing apparatus according to the second embodiment of the present invention when a pulse light emission period of each of a plurality of LEDs is set to 1/n of an exposure time of the CMOS image sensor 108.

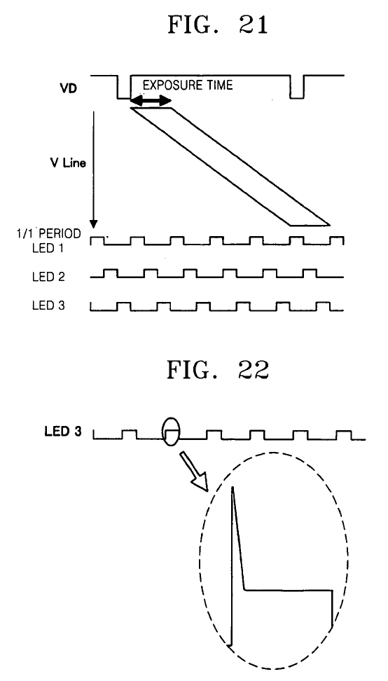

FIG. 21 is an explanatory view showing an example of a relationship between exposure time and pulse light emission of each LED in the photographing apparatus according to the second embodiment of the present invention when a pulse light emission period of each of a plurality of LEDs is set to 1/n of an exposure time of the CMOS image sensor 108. Although an exposure time of a single horizontal line is less than a VD period in FIG. 21, it may be the same as the VD period without being limited the above example. In addition, although the number of horizontal lines is assumed to be 12 also in the example of FIG. 21, it is not limited to such an example in the present invention. A set pulse period or a set duty ratio is not limited to the above example, and if a pulse light emission period of the LED 158 is set to 1/n of an exposure time per horizontal line, a duty ratio may be separately set to have a pattern other than those shown in FIG. 21.

In FIG. 21, a pulse period of each LED is set to 1/1 of an exposure time of the CMOS image sensor 108. Since an instantly flowing current abruptly increases when the LEDs are driven to emit light with the same timing, load on the switch 154 or the LED driver 156 increases. On that account, a flowing electric current may be averaged by causing pulse light emissions of the LEDs to be out of phase with each other, thereby reducing load on a circuit. As a result, integrals of radiation quantities for horizontal lines are all 3 and light is radiated from the LEDs uniformly over the entire screen.

As shown in the example of FIG. 22, if a light emission quantity per pulse increases, it does not form a square like a pulse waveform and an over shoot is likely to occur at the time of initiation of light emission. In order to reduce a spot caused by the over shoot, light emission may be controlled by grouping a plurality of LEDs and causing groups to be out of phase with each other, in addition to shortening a pulse period with respect to an exposure time. In this way, the light emission control is performed by grouping a plurality of LEDs and causing groups to be out of phase with each other, thereby distributing the influence of the over shoot over the entire screen.

Although a plurality of LEDs which emit light at the same wavelength are used as a flash in the second embodiment of the present invention, even when a plurality of LEDs which emit light at the same wavelength is grouped as an LED group and a plurality of LED groups which emit light at different wavelengths are used as a flash, light can be radiated from the LEDs uniformly over the entire screen by causing light emission timings of the LEDs to be different from each other in the above manner. In this case, light emission may be controlled independently for each LED group.

As described above, according to the second embodiment of the present invention, even in case of using a photographing device where exposure timings differ from line to line like in a rolling mode of a CMOS image sensor, by setting pulse light emission periods of a plurality of LEDs which emit light at the same wavelength to 1/n of an exposure time per horizontal line and causing pulses of the LEDs to be out of phase with each other, light from a light emitting unit which performs pulse light emission can be radiated uniformly over the entire screen. Since light can be radiated from the light emitting unit uniformly over the entire screen, it is possible to suppress generation of a noise in a captured image obtained by photographing an object. Moreover, an LED does not need to emit light continuously during exposure of all horizontal lines, thus suppressing damage of the LED, or radiating light to the object with high light intensity even when the LED is used as a flash.

FIG. 22 is an explanatory view showing an example of an over shoot generated when a light emission quantity per pulse is increased.

As is apparent from the foregoing description, according to the present invention, it is possible to provide a photographing apparatus and a photographing method in which light emission control is performed such that a period of light emission or light non-emission of a light emitting unit is set to 1/n of an exposure time even when exposure timings differ from line to line, thereby radiating light uniformly over the entire screen from a light emitting unit which performs pulse light emission and thus suppressing generation of noise in a captured image obtained by photographing an object.

While the present invention has been particularly shown and described with reference to embodiments thereof, it will be understood by those having ordinary skill in the art that various changes in form and detail may be made therein without departing from the spirit and scope of the present invention as defined by the following claims.

For example, a communication function may be provided between the control unit 128 and the LED driver 156, and the LED driver 156 may generate and output a plurality of light emission patterns based on an instruction which is previously received from the control unit 128. In this case, the switch 154 may control only initiation and termination of light emission of the LED 158.

In addition, although there is no period during which all horizontal lines can be exposed at the same time in the above-described embodiments, if a VD period is short, all horizontal lines may be exposed at the same time at a shutter speed which does not cause a hand shake. In this case, if it is determined that a sufficient light emission quantity from an LED can be secured during a period where all horizontal lines can be exposed at the same time, light emission control is performed such that light is emitted from the LED for that period. On the other hand, if it is determined that the sufficient light emission quantity from the LED cannot be secured, the light emission time of the LED may be controlled like in the above-described embodiments.

The present invention can be applied to a photographing apparatus and a photographing method. More particularly, the present invention can be applied to a photographing apparatus and a photographing method in which an X-Y address type photographing device is provided and a light emission means which performs pulse light emission like an LED is used as a flash.

What is claimed is:

1. A photographing apparatus which comprises an X-Y address type photographing device and exposes the X-Y address type photographing device to photograph an object, the photographing apparatus comprising:
a pulse light emitting unit repeating light emission and light non-emission toward the object in association with a photographing manipulation; and
a light emission time control unit controlling light emission such that a period of light emission or light non-emission of the pulse light emitting unit is equal to 1/n of an exposure time of the X-Y address type photographing device, wherein n is an integer greater than 1.

2. The photographing apparatus of claim 1, wherein the light emission time control unit controls light emission of the pulse light emitting unit when an exposure timing of the X-Y address type photographing device differs for every horizontal line.

3. The photographing apparatus of claim 1, wherein the light emission time control unit controls light emission of the pulse light emitting unit during exposure.

4. The photographing apparatus of claim 1, wherein the light emission time control unit controls light emission of the pulse light emitting unit based on an exposure quantity required for photographing the object.

5. The photographing apparatus of claim 1, wherein the pulse light emitting unit comprises a plurality of light emitting units which emit light at the same wavelength or different wavelengths, and the light emission time control unit independently controls a period of light emission or light non-emission for each of the plurality of light emitting units which emit light at the same wavelength or different wavelengths.

6. The photographing apparatus of claim 5, wherein when the plurality of light emitting units emit light at the same wavelength, each of the plurality of light emitting units emits light with different phases.

7. The photographing apparatus of claim 5, wherein the light emission time control unit controls light emission of each of the plurality of light emitting units when an exposure timing of the X-Y address type photographing device differs for every horizontal line.

8. The photographing apparatus of claim 5, wherein the light emission time control unit controls light emission of each of the plurality of light emitting units during exposure.

9. The photographing apparatus of claim 5, wherein the light emission time control unit controls light emission of each of the plurality of light emitting units based on an exposure quantity required for photographing the object.

10. The photographing apparatus of claim 5, wherein the light emission time control unit controls light emission of each of the plurality of light emitting units such that a period of light emission or light non-emission differs for each of the plurality of light emitting units.

11. The photographing apparatus of claim 5, wherein the light emission time control unit controls light emission of each of the plurality of light emitting units such that a duty ratio differs for each of the plurality of light emitting units.

12. A photographing method which photographs an object by exposing an X-Y address type photographing device, the photographing method comprising:
a pulse light emitting operation of repeating light emission and light non-emission toward the object in association with a photographing manipulation; and
a light emission time control operation of controlling light emission such that a period of light emission or light non-emission of the pulse light emitting operation is equal to 1/n of an exposure time of the X-Y address type photographing device, wherein n is an integer greater than 1.
